(19) United States
(12) Patent Application Publication
(10) Pub. No.: US 2026/0148177 A1
(43) Pub. Date: May 28, 2026

(54) Retention-Payback Alignment Framework (RPA): A Velocity-Based Computational Operating System for Profitability and Organizational Alignment

(71) Applicant: Oberation Inc., Dover, DE (US)

(72) Inventor: Mengqian Su, San Francisco, CA (US)

(73) Assignee: Oberation Inc., Dover, DE (US)

(21) Appl. No.: 19/342,572

(22) Filed: Sep. 28, 2025

Related U.S. Application Data
(60) Provisional application No. 63/723,712, filed on Nov. 22, 2024.

(51) Int. Cl. G06Q 10/067

(52) U.S. Cl. CPC G06Q 10/067

(57) ABSTRACT

The RPA framework provides a unified system that connects user retention, organizational interaction points, and financial return through velocity-based measures, enabling real-time profitability determination at scale across siloed data systems. The invention computes and optimizes profitability by connecting two physics-inspired time-based variables-retention and payback, or inactivity and return on investment-across millions of cohorts and segments. A profitability signal is generated by comparing inactivity velocity with payback velocity, transforming profitability assessment into a binary indicator and visualizing projected speeds. By reframing static cohort curves into dynamic velocity signals, the system operationalizes profitability determination in real time within a unified measurement framework. Additional embodiments include integration of alignment measures and profit trajectory uplift, providing leadership with a centralized operating system for decision-making, organizational synchronization, and growth management beyond traditional static reporting, establishing a single source of operational truth.

### CROSS-REFERENCE TO RELATED APPLICATIONS

This application claims the benefit of U.S. Provisional Patent Application No. 63/723,712, filed Nov. 22, 2024, entitled Retention-Payback Alignment (RPA) Framework, the entirety of which is incorporated herein by reference.

### BACKGROUND

The Internet has had many profound effects on global commerce. The explosion of e-commerce, the rapid appearance and growth of on-line business to business exchanges, and the meteoric rise in the market value of Internet firms like VerticalNet, Amazon.com and eBay are some of the more visible examples of the impact it has had on the American economy. Following the first launch of App Store in July 2008, the mobile tech ecosystem also took off with millions of apps changing consumer behaviors, mobile app growth led by gaming, fintech, dating have taken up dominant space for user attention with the rise of social apps such as instagram, snapchat, as well as other consumer sectors. With that the consumer brands whether it's mobile-first, web-first, or traditionally offline dominated, as well as emergence of B2B SAAS services, started to take up the tech ecosystem. The corresponding growth tracking, analytics, and processes have been established since the early 2000s to measure the effectiveness of marketing spend in terms of acquiring users, generating revenue, and driving financial returns.

### Current Problem in the Tech Industry

With the emergency of tech companies in the last 20+ years (2000 to 2025), the organizations are not aligned by design. The cost of misalignment roots from siloed data systems across different units and departments, where teams are disconnected from their respective business targets and business bottom lines in terms of speed to profitability in a real-time understanding.

Tech companies use blended signals across cohorts and segments to understand the company-wide financial health using static and value-based metrics, delaying decision-making and optimization—with different departments using separate data signals to anchor their department targets, connected with metrics such as LTVs (user Lifetime-Values).

The LTV:CAC ratio became widely adopted within the SaaS and venture capital communities in the late 2000s and early 2010s, and thus became a standard growth model for most tech businesses. However, with such a model, cross-functional misalignment remains a common operational challenge for businesses, many companies frequently reported weak or sub-optimal bottom line growth despite top line growth for years. The AI-driven era of algorithmic feeds has further fragmented consumer attention; recent economic slowdown in recent years have pressured companies to lay off headcounts, mostly impacting business departments, to undercut cost in hope to restore cash flow and profitability, resulting in a cycle of slower growth and reduced operating resources, including capital, people, and organizational capacity.

### Current Growth Loop and System

The organizational misalignment systemically happens among product, marketing, finance, and data functions. In existing workflows and processes, profitability models rely heavily on isolated metrics such as Customer Lifetime Value (LTV), Customer Acquisition Cost (CAC), or static cohort retention curves. These methods fail to capture the dynamic velocity relationships that actually govern when an investment becomes profitable.

### Limitations of Prior Art

Retention curves alone measure user survival but not financial recovery.

ROI/ROAS curves are used in isolation, without synchronization to user retention behavior.

Existing dashboards and KPIs remain fragmented, providing no single source of truth (SSOT).

### Opportunity

RPA breaks that entire loop by introducing a real-time alignment operational loop and computation system where it aligns finance, marketing, product, leadership data signals in one framework, with real-time visualization of the velocity of the organization between user retention speed and cash return speed. Making profitability a question of Alignment on organizational decision and execution to bottom line, rather than cost cutting.

The invention is designed specifically for technology, gaming, fintech and SaaS companies. The framework integrates data-driven analytics to unify company-wide siloed data visualizations and strategies.

### BRIEF DESCRIPTION OF THE INVENTION

The Retention-Payback Alignment (RPA) Framework is a layered system of computer-implemented methods and outputs that together provide a real-time profitability and operating alignment model. At the foundation, Layer 1 introduces a velocity comparison engine that evaluates profitability in real time. The velocity-based engine provides the core profitability signal. In certain embodiments, the framework extends beyond the foundational velocity engine to provide Layer 2 outputs, in which the profitability signal is propagated as machine-readable outputs to analytic modules corresponding to product, marketing, and finance functions. Each module consumes the profitability signal for automated or semi-automated decision support, thereby enabling synchronized, cross-functional decision-making and execution data outputs within a single source of operational truth unified in one data system.

In additional embodiments, the system computes an Alignment Index (Layer 3) that quantitatively represents organizational coherence as a compounded function of decision frequency and accuracy across multiple layers. Additional embodiments introduce Profit Trajectory Uplift (PTU) and Profit Velocity Uplift (PVU) indices (Layer 4) to measure velocity improvements in profitability trajectories.

Together, these features form a unified framework that operationalizes profitability and organizational alignment as a real-time Computational Leadership Operating System (Layer 5).

### System Structure

Math layer: Retention, Inactivity, ROI, Payback=formulas.
System layer: Velocity engine=transformation.
Scale: Millions of data points=real technical implementation.
Organizational layer: Connects user retention↔organizational interaction points↔financial return=A Computational Leadership Operating System.

### BRIEF DESCRIPTION OF THE DRAWINGS

FIG. 1 illustrates the origin of the discovery of retention payback alignment RPA framework where profitability happens when retention curves outlasts payback period, a novel discovery that serves as the root of the RPA framework.

FIG. 2a illustrates a retention curve and its inversed inactivity curve (inactivity=1−retention).

FIG. 2b illustrates retention velocity and inactivity velocity as derivatives of retention curve and inactivity curve.

FIG. 3 illustrates multiple inactivity curve embodiments, including churn, disengagement, and drop-off.

FIG. 4a illustrates a return curve (ROI curve), representing cumulative revenue relative to acquisition cost. The slope of this curve is defined as return velocity.

FIG. 4b illustrates the corresponding payback curve, defined as the reciprocal of the return curve (payback=1/ROI). The slope of this curve is defined as payback velocity. This reciprocal relationship enables the invention to operationalize profitability by comparing payback velocity against return velocity where payback velocity=return velocity.

FIG. 5 illustrates a retention curve and a return (ROI) curve presented together in a unified framework to showcase the speed of user retention vs speed of financial return.

FIG. 6a illustrates a profitable case where payback/return velocity exceeds inactivity velocity and the return curve reaches 1 before the cohort diminishes.

FIG. 6b illustrates an unprofitable case where inactivity velocity exceeds payback velocity, or where the return curve fails to reach 1 before the cohort diminishes.

FIG. 6c illustrates the profitability projection before and after cohort payback breakdown.

FIG. 7a-illustrates an embodiment in which the profitability signal generated by the RPA velocity engine is propagated to machine-readable outputs to analytic modules (e.g., product, marketing, finance), each module configured to consume and process signals algorithmically for decision optimization.

FIG. 7b-illustrates an embodiment in which the profitability signal generated by the RPA velocity engine is propagated to analytic modules (e.g., product, marketing, finance), each module's corresponding functions in relation to the operating data systems. Finance for planning and measurement, product for segment optimization, and 3 department alignment for leadership decision-making.

FIG. 8a illustrates a block diagram of a system for computing profitability signals across the user acquisition loop at the millions of cohort levels used in tech operation in traditional old data processes.

FIG. 8b illustrates a block diagram of a system, the invention of this system, for generating profitability measurement across the user acquisition and retention loop using a real-time binary or continuous profitability signal computed and transmitted by the system via the RPA Framework

FIG. 9 illustrates the definition of Alignment=Function of (Frequency×Accuracy) in organizational interaction nodes where nodes include decision and execution of each financial target, used by leadership, product, marketing and finance teams.

FIG. 10A illustrates an Alignment Index calculated as A(x)=Σ[1+a] (Frequency(a)×Accuracy (a))\hat{ }N to represent true Organizational Compound Alignment Signal

FIG. 10B illustrates an Alignment Index calculated as A=(f×a)\hat{ }n, a simplified Compound Alignment index for organizational Alignment system representation.

FIG. 11 illustrates the invention RPA framework as a 3D velocity system where the three dimensions are shown as financial KPI (revenue and profitability), time (payback), and alignment (synchronization) in one system

FIG. 12 illustrates the visual impact of compound alignment across organizational layers from top down where it positions RPA as a leadership data framework.

FIG. 13 illustrates the definitions and measurement of Profit Trajectory Uplift (PTU) comparison where PTU is defined as the speed increase of payback target between two time points. PTU can also be named as PVU—Profit Velocity Uplift or Payback Gain.

FIG. 14 illustrates a Profit Trajectory Uplift (PTU) signal in a RPA system. PTU can also be named as PVU—Profit Velocity Uplift, Velocity Gain, or Payback Gain.

### DETAILED DESCRIPTION OF THE INVENTION

The present invention, referred to as the Retention-Payback Alignment (RPA) Framework, is a computer-implemented system that transforms the way organizations measure and operationalize profitability and alignment. While prior profitability models rely primarily on static, value-based metrics such as Customer Lifetime Value (LTV) or Return on Ad Spend (ROAS), the present invention introduces a velocity-based framework that dynamically compares time-based variables to generate real-time profitability signals across millions of cohorts and organizational data points.

The invention is not limited to a single embodiment but rather encompasses a set of progressive layers, each of which may be implemented independently or in combination:
Layer 1—Core Velocity Engine for Profitability: Computes a profitability signal by comparing user inactivity velocity against payback velocity, and confirming whether the return curve (ROI) reaches one before the inactivity curve reaches zero. This is the foundational module, originally described in the provisional application.
Layer 2—Cross-Functional Signal Distribution: Propagates the profitability signal as machine-readable outputs to analytic modules corresponding to product, marketing, finance, and leadership functions, enabling synchronized decisions across siloed systems. Data ingestion and harmonization may be implemented through data pipelines, including ETL (Extract-Transform-Load) pipelines, streaming pipelines, or API-based integrations (see Glossary), to ensure consistency across heterogeneous data systems prior to cross-functional distribution.
Layer 3—Alignment Index: Introduces a mathematical definition of organizational alignment as a compounded function of frequency and accuracy of decisions across multiple layers. This embodiment operationalizes alignment as a measurable index rather than a qualitative notion.
Layer 4—Profit Trajectory Uplift (PTU): Defines a velocity-based uplift index that measures changes in profitability speed relative to a baseline trajectory. PTU (also referred to as Profit Velocity Uplift, PVU, or Payback Gain) provides a forward-looking measure of organizational improvement.
Layer 5—A Computational Leadership Operating System (OS): Provides a unified interface that integrates outputs from Layers 1-4 into a centralized operating system for real-time decision-making, organizational synchronization, and growth management. The Leadership OS serves as the culmination of the framework, transforming profitability computation into a continuous operating signal for executive management.

In some embodiments, the system is implemented as a modular software platform where each layer is optional, and the invention may include any one of these modules, a subset, or the full stack of layers. The use of the term “comprising” throughout this description and the claims is intended to denote that the system may include additional features, sub-modules, or integrations without departing from the scope of the invention.

### Layer 1: Core Velocity Engine

The Retention-Payback Alignment (RPA) Framework introduces a velocity-based computation system for evaluating real-time profitability assessment that unifies user retention, organizational interaction points, and financial return. This section describes the foundational layer of the framework, which compares user inactivity velocity against payback velocity (see Glossary definitions of Inactivity Velocity and Payback Velocity), and confirming whether the return curve (ROI) reaches one before the inactivity curve reaches zero.

Such methods use time-based viable Speed and Velocity to connect the central metrics of an organization's data across different systems, enabling real-time profitability signals across an entire organization.

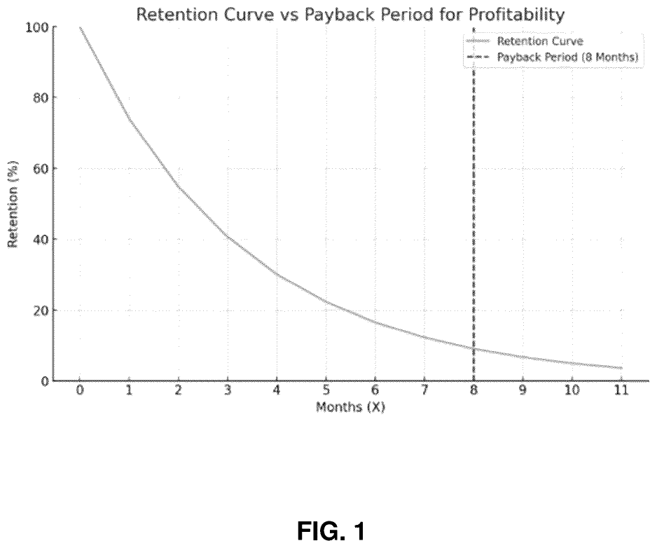

### 1. Retention and Inactivity Curves (FIG. 1)

A user cohort may be represented by a retention curve, defined as the percentage of active users over time. The inactivity curve is the inverse of the retention curve, representing the cumulative fraction of users who have become inactive. While these curves are known in descriptive analytics, the present invention RPA framework transforms them into velocity-based signals and integrates them into a computational process for real-time profitability determination, bypassing the traditional approach using the projected life-time-value (LTV) as the anchor key of the cross functional data connections.

The inactivity curve provides a direct measure of attrition, and may take multiple forms depending on the user population:

$$Inactivity Curve = 1 - Retention$$

a churn curve showing complete attrition;
a disengagement curve reflecting temporary or partial inactivity; or a drop-off curve illustrating accelerated early-stage inactivity.

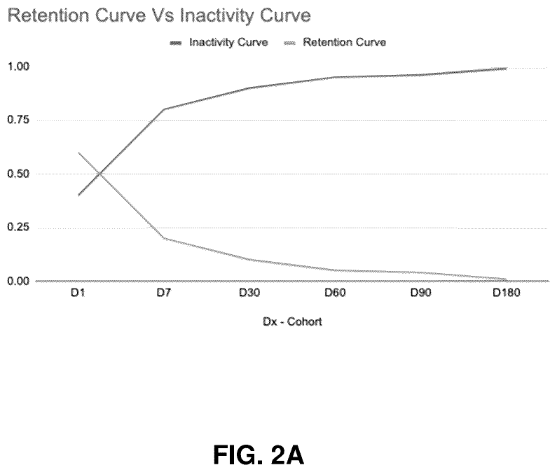

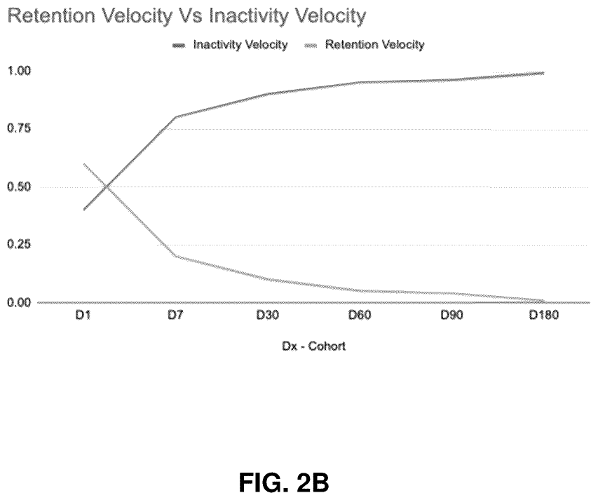

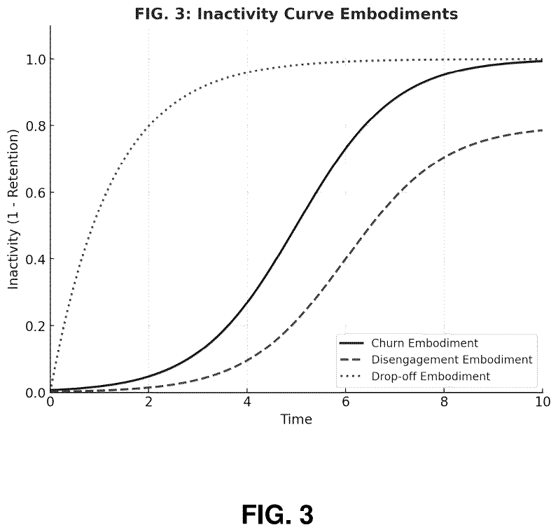

### 2. Velocity Measures (FIG. 2-3)

One key invention of the RPA system is the transformation of retention curve and return curve as math analysis to Velocity Signals, giving physics meanings to these curves and by doing so, converting data of different dimensions (dynamic vs. static) into the same view, such as retention and payback-attributing to synchronization-later defined as Alignment module-organizational wide.

The system continues to convert projected curves as velocity metrics:

Inactivity velocity: the rate of change (slope) of the inactivity curve, representing how quickly users disengage.

Retention velocity: the rate of change of the retention curve.

Churn velocity: an alternative expression of inactivity velocity, describing the rate of cohort attrition.

Disengagement velocity and drop-off speed: specific embodiments that capture different disengagement patterns.

These definitions allow the system to model user activity not only in cumulative form, but in dynamic terms of speed and velocity.

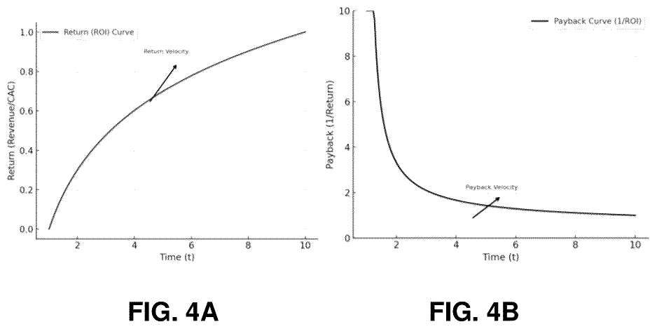

### 3. Payback Velocity and Return Curve (FIGS. 4a and 4b)

One novel approach of the framework introduces the velocity connection between payback and return where return lines as speed can represent payback speed/velocity:

Return curve (ROI curve): the normalized cumulative revenue per user (ARPU) divided by Customer-Acquisition-Cost (CAC). A return curve value of 1 indicates that acquisition cost has been fully recovered.

Payback Curve: the reciprocal of the return curve (1/ROI).

Payback Velocity: the rate at which cumulative revenue per user (ARPU), relative to customer acquisition cost (CAC), increases over time, derivative of the Payback Curve; mathematically equivalent to the reciprocal slope of the return curve.

FIG. 4a illustrates a return curve (ROI curve), representing cumulative revenue relative to acquisition cost. The slope of this curve is defined as return velocity.

FIG. 4b illustrates the corresponding payback curve, defined as the reciprocal of the return curve (payback=1/ROI). The slope of this curve is defined as payback velocity. This reciprocal relationship enables the invention to operationalize profitability by comparing payback velocity against inactivity velocity.

Explicitly state that in different contexts this may also be called:
Cash flow curve (finance/accounting),
Recoup curve (media/entertainment, investment),
ROI curve (general business),
ROAS curve (marketing),
or simply Return curve.

While return curves and ROI calculations are known, the present invention RPA frameworks uniquely recognizes that payback velocity can be expressed as the reciprocal of return (1/ROI). This relationship allows profitability to be operationalized to connect financial return data with user retention via time.

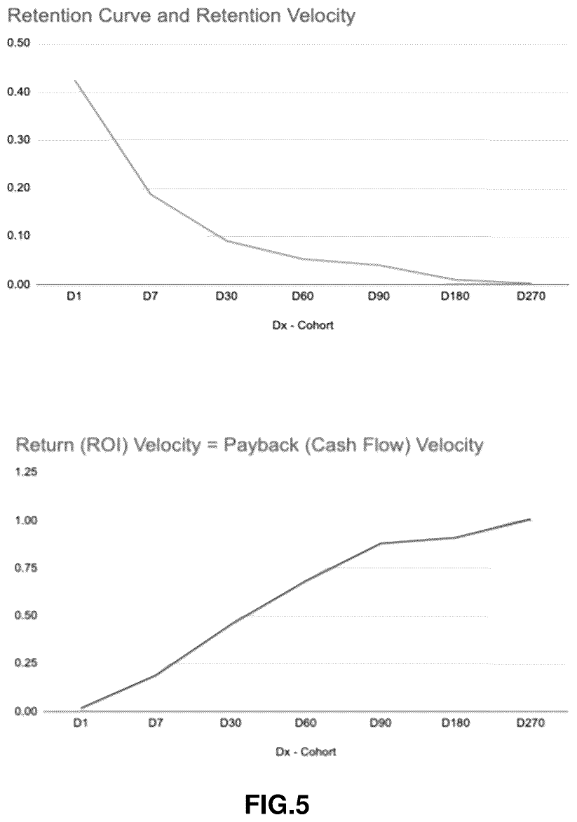

### 4. Retention Velocity and Return Velocity (FIG. 5)

FIG. 5 shows a retention curve (declining) and a return curve (increasing) plotted together in a unified framework. In prior arts, retention and financial return were measured separately, or retention was sometimes shown alongside the lifetime value curve (LTV). However, such comparisons did not serve the purpose of operationalizing speed to profitability.

The RPA system gives the side-by-side computed comparison curves new meaning:
Retention Velocity→user survival (behavioral).
Return/ROI Velocity→revenue recovery vs acquisition cost (financial).

As unified them mathematically by introducing:

$$\begin{matrix}Inactivity Curve = 1 - Retention \\ Payback curve = 1 / ROI\end{matrix}$$

The present invention provides new meaning by explicitly pairing retention with return (ROI). This reframing establishes a coherent framework in which user attrition and cost recovery share a common velocity dimension, thereby enabling direct comparison and operationalized real-time profitability determination across the data systems of the whole organization.

### 4. Profitability Condition

The invention deems cohort profitable only if two conditions are satisfied, in a computed scenario either with existing data or projected data scenario:
Velocity test: Payback velocity exceeds inactivity velocity (the speed of cost recovery outpaces the speed of disengagement).

Return curve test: The return curve reaches a value of 1 (full customer-acquisition-cost CAC recovered) before the inactivity curve reaches complete disengagement (i.e., before the cohort is exhausted).

This dual condition ensures that profitability is not only projected by velocity but actually realized in the cohort's lifetime.

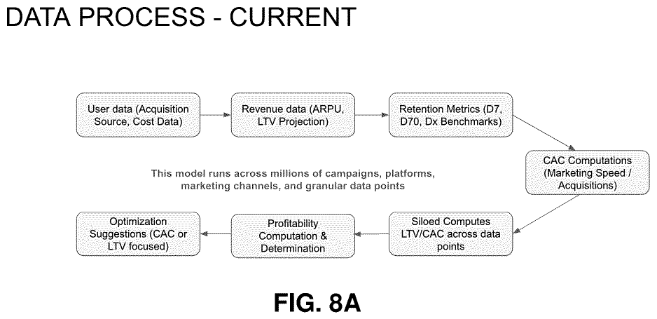

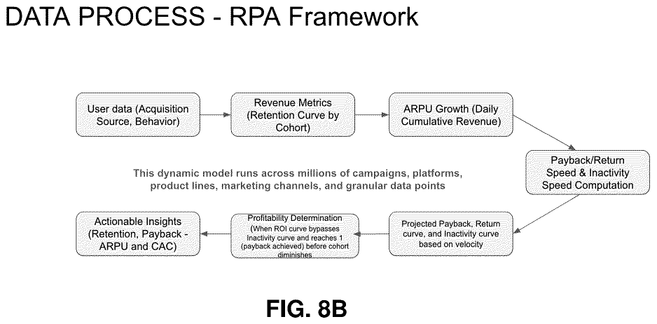

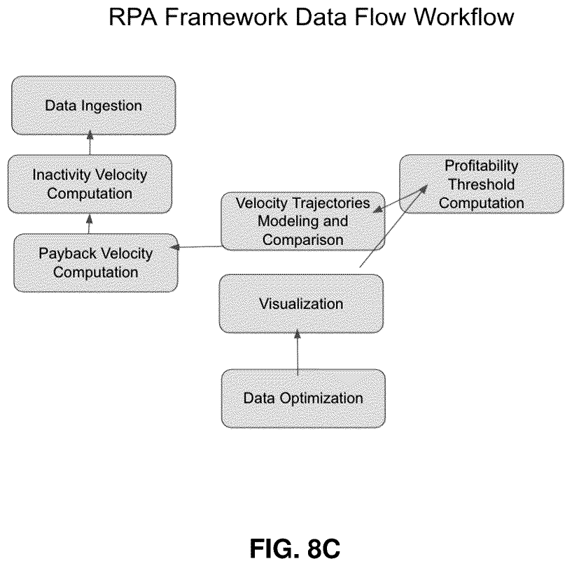

See FIG. 8b.

The above condition applies to measure both historical and new cohorts via machine learning projection, enabling real-time understanding of the profitability via a unified lens of user retention and financial timeline in one view.

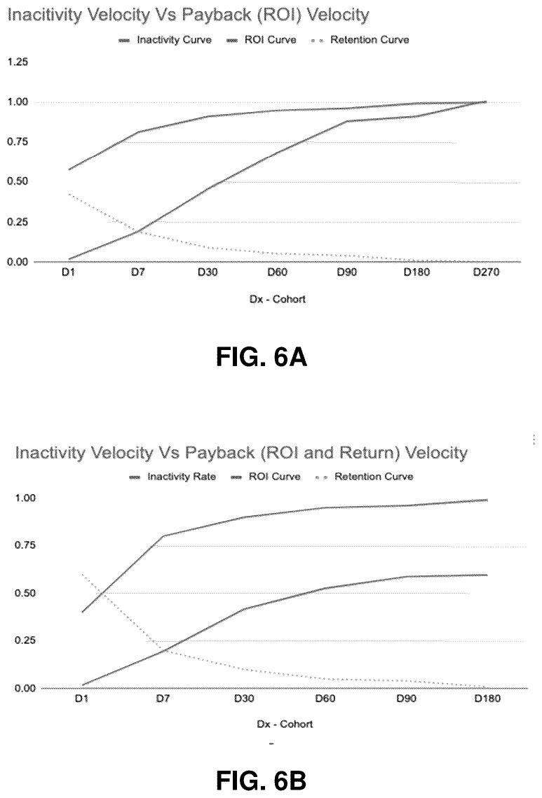

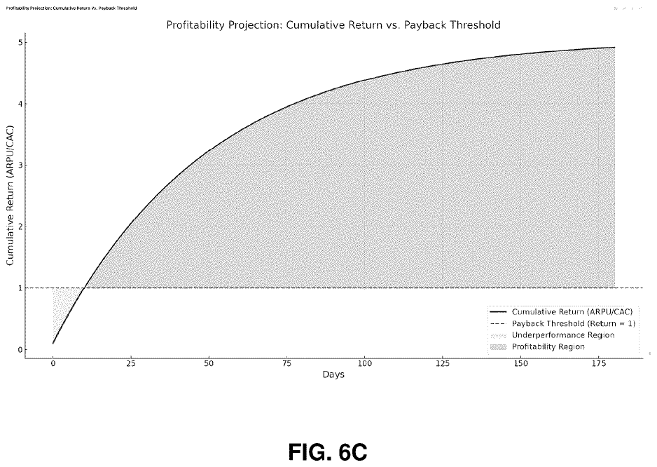

5. Profitable and Unprofitable Cases (FIG. 6a, 6b, 6c)—Velocity Comparison Unified in One View

At the center of this framework lies the core comparison of the two speed curves in order to centralize profitability signals into the one signal and one system view across a tech organization, empowering leadership decision-making via one system signal with precision.

FIG. 6a illustrates an embodiment of the invention in which profitability determination (across all cohort dimensions) is based on comparing an inactivity velocity and a payback (return) velocity. The retention curve (dotted-bottom) represents the fraction of active users over time. The inactivity rate (top) represents the derivative of the inactivity curve, while the ROI curve (middle) represents cumulative revenue relative to acquisition cost. Profitability is achieved when the payback velocity exceeds the inactivity velocity and the ROI curve reaches a value of one before the inactivity curve approaches complete disengagement.

FIG. 6b illustrates an unprofitable case according to embodiments of the invention. The retention curve (dotted-bottom) shows the percentage of active users over time. The inactivity curve (top) shows the cumulative disengagement, while the ROI curve (middle) represents cumulative revenue relative to acquisition cost. In this case, the inactivity curve reaches a value of one (full attrition) before the ROI curve reaches a value of one, indicating that the cohort fails to achieve profitability.

These cases demonstrate how velocity comparison combined with return curve evaluation yields a real-time profitability signal (yes/no) in one view via inactivity curve's velocity, one step further in unifying a siloed data system.

### Advantages of This One View System:

Real-Time Computer Insights and Decision-Making: Enables immediate data visualizations for underperforming and over performing cohorts.
Granular Insights: Cohort and Segment-specific real-time profitability trajectory allows tailored data strategies.

Predictive Capability: Projects the trajectory of time-based profitability without using the static ROAS (LTV/CAC) as determination.

### Key Technical Workflow Enhancements (FIG. 6c):

Before Payback Breakeven: Computes cash flow for operational sustainability. After Payback Breakeven: Computes long-term profitability through retention-centric growth.

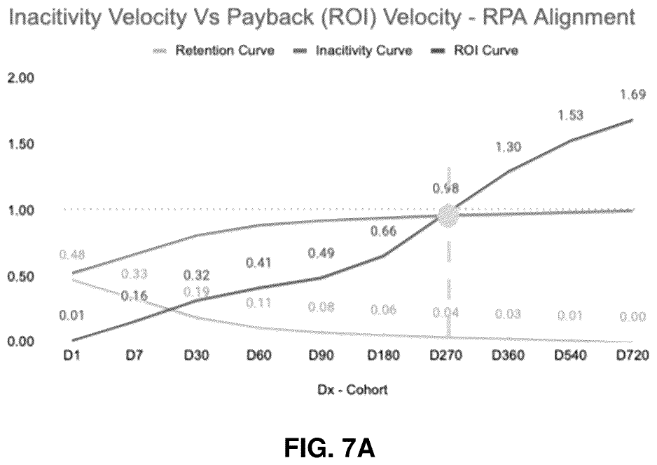

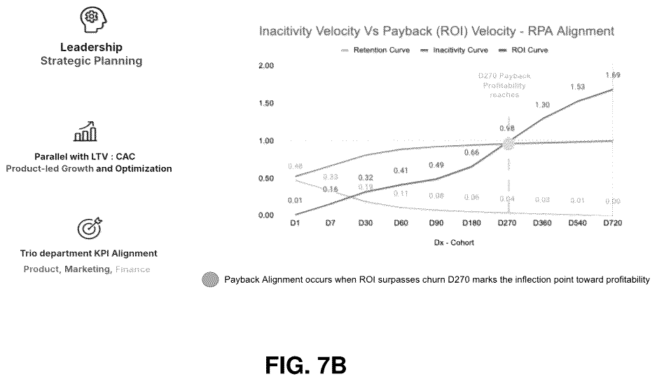

### 6. Trio Department Signal Alignment (FIG. 7)

As shown in FIGS. 7a and 7b, while the system outputs the velocity comparison through the dynamic comparison between inactivity and payback/ROI velocity, it also outputs the actual payback time (day to profitability point) on the chart on the X axis. When such computation is done at the cohort and user-segment level across millions of data points per organization. In this system, profitability signals are propagated as machine-readable outputs to analytic modules (product, marketing, finance), which empowers a holistic computation and analysis on the system truth of a tech company's real-time projected performance financially and operationally. The resulting profitability signal connects the dynamic relationships between user retention, organizational interaction points (e.g., decision and execution frequencies across functional teams), and financial return in a unified system via velocity. Such signals constitute a holistic alignment framework across the Organizational through time-based payback signals to align on targets, strategies and behaviors based on velocity data outputs real-time.

### 7. SYSTEM EMBODIMENT (FIG. 8)—DATA PROCESS OLD VS NEW ON PROFITABILITY

Below is a holistic breakdown of the comparison between the computation of old data process around profitability optimization across user acquisition loops vs the new data process using the novel RPA framework, which affects the organizational data process and movements towards collective efforts to profitability. The bigger an organization is, the more collective synergies (as a result of responding to the RPA system signals) the system will systematically output to improve velocity towards achieving the bottom line.

Novel Data and Profitability Process Workflow (Old FIG. 8a vs. New FIG. 8b):

### Data Flow Diagram

### 1. Current Computation Process for Profitability Optimization (FIG. 8a):

Input: Historical retention and ARPU data to model out valued based LTV

Input: CAC

Output: Static payback period, blended across cohorts, profitability calculated as a valued based LTV-CAC or LTV/CAC

Limitation: No dynamic or time-based granular insights

See FIG. 8a

### 2. New Computation Process: RPA Framework (FIG. 8b)

Input:

Retention Data (by cohort)

ARPU/CAC Data

Segmentation (Channel, Device, User Type)

Process:

Compute Retention Velocity: The rate at which users are retained or continue to remain active over time.

$$Compute Inactiity Velocity = 1 - Retention$$

Compute Payback Velocity: Rate at which ARPU accumulates relative to CAC.

Compute and Project velocities: Identify whether payback velocity exceeds inactivity velocity before the cohort diminishes.

Visualize profitability trajectory: Dynamic graphs highlighting underperforming cohorts.

Output:

Real-time profitability projections.

Cohort-level insights and optimization recommendations.

(FIG. 8a): Traditional Old Profitability Optimization Process

Focuses on LTV/CAC comparison.

### Relies On:

LTV projections based on historical benchmarks.

Retention and ARPU metrics aggregated into long-term trends.

Insights are centered on adjusting CAC or improving LTV and ROAS, often in silos.

(FIG. 8b): RPA Framework Process for Profitability Optimization Focuses on Retention vs. Payback Velocity comparison.

### Directly Aligns:

Retention curves with payback speed and Inactivity speed.

Cohort-level insights with actionable strategies real-time.

### Insights Prioritize:

Extending retention curves.

Speeding up payback.

Tailoring strategies across cohorts (paid, organic, VIP, etc.).

The RPA framework introduces compute generated, dynamic speed-based analysis for earlier, more precise interventions, reducing dependency on static metrics like LTV

Old Workflow:

Siloed Systems: Marketing computes LTV and ROAS, while product and finance systems receive aggregated data and delayed insights.

Inaccuracy: LTV projections are based on historical, often aggregated data, which may not reflect real-time changes in user behavior.

Inefficiency: Limited ability to address unprofitable cohorts early due to lagging or inaccurate insights.

New Workflow with RPA Framework for Profitability Optimization:

Data Integration Layer:

Connects real-time APIs from marketing or attribution platforms (e.g., Meta, TikTok, Appsflyer) and internal product analytics.

Employs privacy-preserving data aggregation to ensure compliance while maintaining granularity for analysis.

### 2. Algorithmic Core:

### Time-Series Analysis:

Retention and return curves are computed using algorithms that dynamically model user behavior over time.

### Velocity Comparison:

Calculates the derivative (speed) of retention and return curves to predict whether retention will outpace payback in time.

### Predictive Modeling and Machine Learning:

Uses historical cohort data to simulate future retention and return curves, enabling early detection of unprofitable cohorts.

### 3. Action Automation:

Sends alerts to product teams when a cohort's inactivity velocity exceeds its payback velocity, prompting immediate intervention.

Provides optimized acquisition recommendations to teams for underperforming segments.

Generates retention benchmarks for cohorts based on historical CAC trends and benchmarks and projected payback period.

### 4. Visualization Engine:

Uses advanced data visualization techniques to display operational metrics and profitability projections in an intuitive format.

A Real-time unified interface module that is tailored for different teams:

Marketing: Campaign-level profitability.

Product: Cohort or Segment-specific retention goals.

Finance: Cash flow and profitability alignment.

### Computational Novelty:

The invention introduces key computational innovations—introducing physics-inspired dimension (Inactivity Velocity, Payback and ROI Velocity)—using speed as a key metrics that ties the connection of velocity metrics and time, empowering computation of data processing: Dynamic Cohort-Level Analysis: Real-time computation of retention and payback curves, replacing static LTV-based static profitability computations.

Time-Based Metrics: Integration of velocity-based metrics to model the dynamic interplay of retention and payback, bypassing delayed dependencies on LTV updates.

Automated Decision Support: Machine learning models predict profitability outcomes, enabling proactive interventions by product and marketing teams.

Unified Data Workflow: Centralized processing of data across marketing, product, and finance data systems to eliminate cross-functional inaccuracies in optimizing optimal profitability outcomes.

### Summary: Technical Problem and Solution

### Technical Problem

Existing profitability models lack real-time, velocity-based alignment of retention and payback dynamics, leading to inefficiencies.

### Technical Solution

A computer-implemented process that dynamically computes and visualizes Inactivity and payback velocities, enabling actionable insights into cohort-level profitability.

See FIG. 8c

### Inputs and Outputs (FIG. 8c)

Here is the workflow diagram for the RPA Framework that the computer generates. It demonstrates the data flow and key processes, including:

Data Ingestion: Aggregating cohort data such as retention, ARPU, CAC, and segmentation.

Inactivity Velocity Computation: Measuring the rate of user decay over time.

Payback Velocity Computation: Determining the rate at which ARPU accumulates to cover CAC.

Comparison of Velocities and Modeling Projections: Analyzing the interplay between Inactivity and payback velocities.

Profitability Threshold Analysis: Computing and Identifying whether a cohort reaches Return=1 before Inactivity diminishes.

Visualization: Presenting the insights in a dynamic chart, across millions of cohorts

Optimization Recommendations: Suggesting actions to align underperforming cohorts with profitability targets.

### Layer 2—Cross-Functional Signal Distribution and Operationalization

The above module created a velocity comparison engine by distributing profitability signals as machine-generated outputs to multiple functional modules. Each module represents a different aspect of the organizational key performance lever's trajectory, which outputs data trends that guide decision and execution process and direction, and organizational synchronization, with the organization operating from the same underlying computational signal, thereby ensuring consistency of input data across silos (Revisiting FIG. 7a, 7b).

Product module: receives profitability trajectory data and may adjust feature prioritization models.

Marketing module: receives the same signal and may adjust customer acquisition optimization parameters.

Finance module: receives the signal to update forecasting algorithms or budget allocation models.

Such a system connects decision-making into real-time signals aligning strategy with execution without siloed system signals, misalignment and gaps in data signal reading.

Unlike prior systems where each department monitors its own KPI signals, the present invention enforces alignment by propagating a single profitability indicator.

Product teams may adjust retention experiments based on thresholds where inactivity velocity approaches payback velocity.

Marketing may use the signal to adjust acquisition spend and customer-acquisition-cost (CAC) in real time.

Finance may use the same signal to forecast cash runway.

This distribution allows every function to make decisions from a synchronized basis, preventing silos and ensuring resource allocation aligns with profitability dynamics.

### Layer 3—Alignment Index (Spec Embodiment Only)

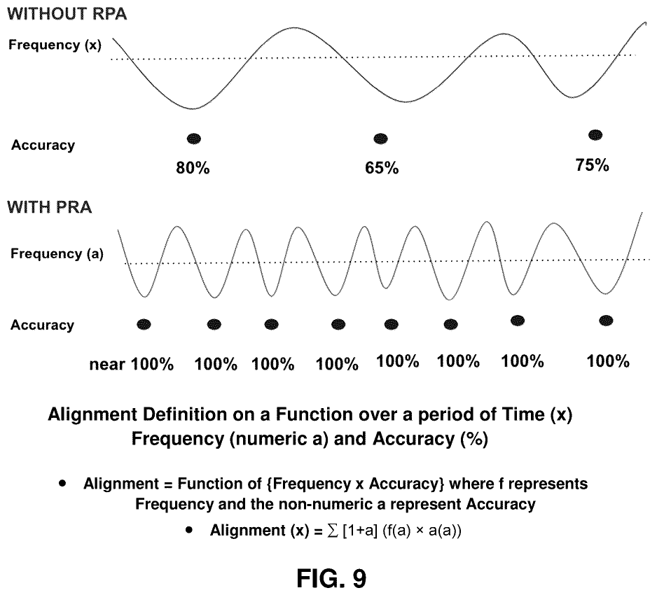

The 3rd embodiment of the invention revolves around the Novelty of the introduction of mathematics of Alignment as an Impact index of the Organizational Behavior while aligning with on RPA's data outputs and visual trajectory line.

Where the alignment of a single department function over a period of time x could be defined as FIG. 9 Alignment (x)=Function of {Frequency×Accuracy} over the specific actions of that function over the period of time x where the actions could be defined as decision nodes if its leadership team and execution nodes if it's for business teams, such as product nodes, marketing nodes where each node is one team action.

In a math term, the collective Alignment of that team could be defined as Alignment (x)=Σ[1+a] (f(a)×a(a)) within a selective time frame x, with the number of frequency (numeric a) compounded by the layer of the organization N; where f represents frequency and the non-numeric a represent accuracy.

The organizational Compound Alignment output thus defined as A(x)=Σ[1+a](f(a)×a(a))\hat{ }N (functional summation), and written as A=(f×a)\hat{ }n (compound form) in simplified format for conceptual understanding.

In some embodiments, the Alignment Index may alternatively be expressed in additive form, without compounding across layers, such that organizational alignment is computed as the direct sum of frequency and accuracy measures across decision and execution nodes. This additive variant may be preferred in scenarios where cross-layer dependencies are limited or where alignment measurement is intended to remain strictly linear.

Such definition qualifies Alignment outside of a traditional “slogan word” in business Organization to a mathematical and science-based index, conceptually equivalent to multi-touch attribution for marketing's paid acquisition attribution, where perfect attribution is science-based but raw data is hard to capture in full presence.

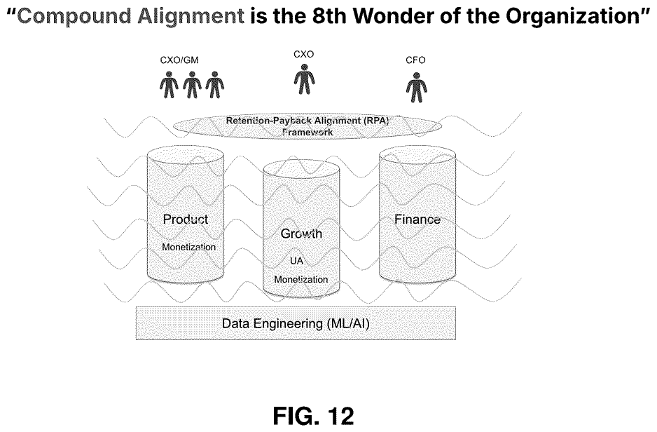

The impact Alignment Index explains a concept where Compound Alignment can create the “8th wonder of the organization” by relentless pursuit of optimal alignment of speed (FIG. 12), which will translate into optimal business bottom collectively as an organization.

FIG. 9: Alignment=Function of {Frequency×Accuracy}

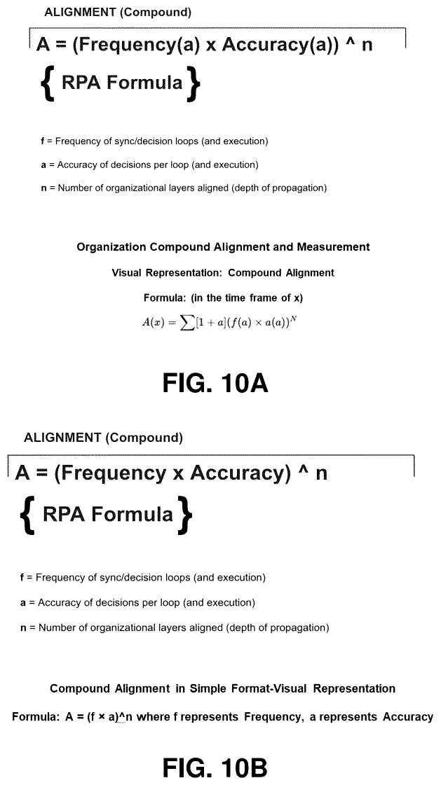

FIG. 10a: Compound Alignment=A(x)=Σ[1+a] (f(a)×a(a))\hat{ }N (functional summation)

FIG. 10b: Compound Alignment Simplified A=(f×a)\hat{ }n

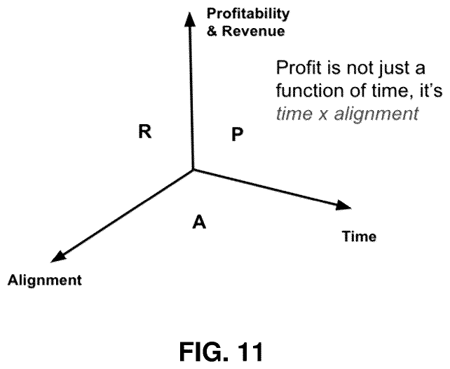

FIG. 11: A 3D Velocity System comprised of {Profitability, Time, Alignment}

FIG. 12: Compound Alignment creates system compounds

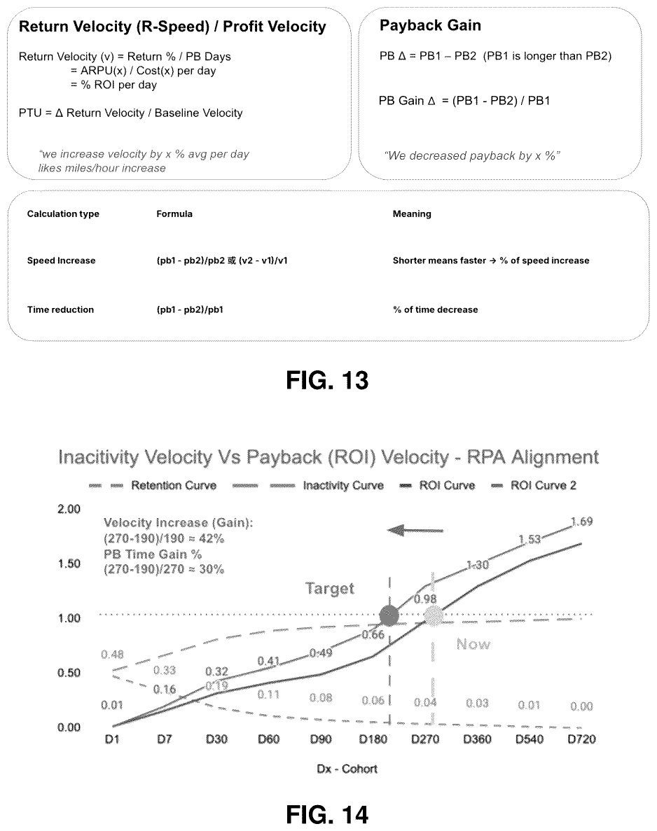

### Layer 4—Profit Trajectory Uplift (Spec Embodiment Only—FIGS. 13a and 13b)

The framework further introduces new metrics of velocity measurement for success—(FIG. 13a) Profit Trajectory Uplift (PTU), or Profit Velocity Uplift (PVU), to compute the velocity gain to the bottom line in terms of how fast collectively an organization can reach bottom through improving speed. Such indexes can be displayed in velocity-based or time-based format.

In some embodiments, PTU may alternatively be expressed as slope differentials between observed and baseline profitability trajectories, rather than as uplift ratios, emphasizing the directional rate of change in profitability velocity.

Such an index visualizes the speed line change (FIG. 13b) between different output targets on payback with the payback signal operationalized across the organization as the target metrics mobilizing the system-wide cross-functional data optimization and synchronization/speed of decision, optimization and workflow of an organization.

Where Speed to Target is at the center of operation as northern light targets for driving Organizational Alignment (core of this invention), PTU signifies a data input and output that directs, measures, and guides organizational performance and serves as the operational rhymes and pulses. It empowers a velocity based target, a specific payback signal, for organization to move into the same direction in sync, and adjust speed accordingly based on data outputs and strategic adjustments based on data outputs.

Other terminologies of PTU (FIG. 13a)

Calculated by Speed, also named as PVU—Profit Velocity Uplift, Velocity Gain

Calculated by Time—Payback Gain or Loss

Data Glossary (FIG. 13a):

Speed Improvement Definition

$$\begin{matrix}Return Velocity ( v ) = Return \% / Payback Days \\ PVU ( Profit Velocity Uplift ) = Δ Return Velocity / Baseline Velocity\end{matrix}$$

PTU=(Payback1−Payback2)/Payback2 wherein Payback1 is defined as the baseline payback time point and Payback2 is defined as the improved payback time point, each corresponding to the exact time at which cumulative return equals acquisition cost under a given scenario. PVU and PTU both represent Velocity Gain or Speed increase

### Time Reduction Definition:

Payback Gain Δ=(Payback1−Payback2)/Payback1 equivalent to % of time decrease, wherein Payback1 is defined as the baseline payback time point and Payback2 is defined as the improved payback time point, each corresponding to the exact time at which cumulative return equals acquisition cost under a given scenario.

### Layer 5: a Computational Leadership Operating System (OS)

In certain embodiments, the system is deployed as a real-time Leadership Operating System (OS), in which profitability signals, alignment indices, and trajectory outputs are integrated into a centralized a unified interface module configured to integrate and display outputs.

This unified interface module may include:
Visualizations of Retention, Return, and Inactivity Curves;
Profitability Signals, Alignment index, Profit Trajectory Uplift—PTU outputs;
Real-time and machine learning sub-modules configured to forecast trajectory changes;
Predictive trajectory models for scenario planning;
In some embodiments, the Leadership Operating System further includes integration of standard business metrics modules including, but not limited to, Customer Acquisition Cost (CAC), Average Revenue Per User (ARPU), revenue, profits (projected and actual), retention rate (RR), and other financial or operational indicators. These may be displayed in visual or forecast formats, combined with the profitability signals, alignment modules, and PTU or velocity outputs of the invention.

By consolidating signals into a unified interface, the invention enables leadership to operationalize profitability and alignment as a single operating system for decision-making, synchronization, and growth management.

### Alternative Embodiments: ML & API Deployment

In some embodiments, the system may incorporate machine learning (ML) models to predict future profitability thresholds. The ML projections are not themselves the invention, but are integrated into the system process of profitability evaluation, alignment computation, or PTU calculation. The novelty resides in embedding predictive modeling into the unified framework of curve velocity comparison, organizational alignment, and profitability signaling.

For example, regression models may forecast when the return curve will reach unity (1 or 100%) given current retention dynamics, or anomaly detection models may trigger alerts if inactivity velocity is projected to exceed payback velocity.

In another embodiment, the system exposes an application programming interface (API) through which external systems—such as business intelligence dashboards, ad platforms, or financial planning software—can request profitability signals in real-time. This embodiment enables SaaS deployment at organizational scale, synchronizing millions of data points across cohorts and segments without human intervention.

### EMBODIMENTS

Exemplary embodiments in claim-type format are given below. They are not intended to be actual claims.

### Independent Embodiment 1 (Core Velocity Engine for Profitability)

A computer-implemented method for evaluating profitability across different segments of cohorts and users, comprising:
generating a retention curve representing a fraction of users active over time;
generating an inactivity curve defined as one minus the retention curve;
generating a return (ROI) curve representing cumulative revenue relative to acquisition cost;
defining a payback curve as the reciprocal or inverse function of the return curve;
computing an inactivity velocity from the inactivity curve;
computing a payback velocity from the return (ROI) curve;
comparing the retention curve with the return curve to evaluate the dynamic relationship between user activity and financial recovery; and
comparing the inactivity curve with the return curve to evaluate the dynamic relationship between user activity and financial recovery; and
determining profitability signal based on 1) comparing whether the payback velocity exceeds the inactivity velocity and 2) the return curve reaches one before the inactivity curve reaches zero;
wherein the profitability signal is generated in real time across multiple cohorts and user segments.

### Dependent Embodiments (Core Engine Extension)

The method of embodiment 1, wherein the return curve is expressed as an ROI curve, ROAS curve, recoup curve, or cash flow curve.

The method of embodiment 1, wherein the inactivity curve is alternatively referred to as a churn curve, disengagement curve, or drop-off curve.

The method of embodiment 1, wherein the profitability signal is further visualized as a chart displaying retention, churn, ROI, and payback curves with color-coded cohort profitability.

The method of embodiment 1, further comprising transmitting the profitability signal as a machine-readable output to one or more analytic, operational, or decision-making modules.

The method of embodiment 1, wherein the analytic modules include a product module, a marketing module, and a finance module, each configured to consume the profitability signal for decision-making.

The method of embodiment 1, wherein the profitability signal module further incorporates machine learning models configured to forecast when the return curve will reach a predefined threshold based on current retention or inactivity dynamics.

The method of embodiment 1, wherein predictive or machine learning models are employed to estimate future payback velocity or inactivity velocity from historical or real-time cohort data.

The method of embodiment 1, wherein anomaly detection models are applied to identify when projected inactivity velocity is expected to exceed payback velocity, triggering alerts or control signals.

The method of embodiment 1, wherein the profitability determination incorporates organizational interaction points, including decision frequencies or performance events across functional teams.

The method of embodiment 1, wherein the profitability determination is further associated with organizational interaction patterns derived from decision-making or performance data of functional teams.

The method of embodiment 1, wherein the profitability determination is output as a binary or continuous signal for real-time operational decision-making.

### Independent Embodiment 2-5 (Alignment Index+Compound Alignment)

### Embodiment 2 (Alignment Index—Functional Form)

The system of embodiment 2, further comprising:

A computer-implemented method for evaluating Organizational Alignment across different business data functions, comprising:
computing an Alignment Index defined as a function of frequency and accuracy for a given organizational node, wherein the node represents a team action such as a leadership decision node or a business execution node;
wherein the Alignment Index is evaluated over a defined time period to quantify the impact of organizational behavior.

### Embodiment 3 (Alignment Index—Mathematical Form)

The system of embodiment 2, wherein the Alignment Index is calculated as:

$$Alignment ( x ) = Function of \{ Frequency \times Accuracy \} ,$$

Alignment(x)=Σ[1+a](f(a)×a(a)) within a selective time frame x,

where f(a) represents frequency and a(a) represents accuracy of a given organizational node, wherein the node represents a team action such as a leadership decision node or a business execution node;

### Embodiment 4 (Compound Alignment Index—Functional Form)

The system of embodiment 2, further comprising:
computing a Compound Alignment Index defined as a compounded function of Alignment Indices across multiple organizational layers, including vertical layers and horizontal layers (cross-functional teams);
   wherein the Compound Alignment Index represents the collective organizational alignment over time.

### Embodiment 5 (Compound Alignment Index—Mathematical Form)

The system of embodiment 4, wherein the Compound Alignment Index is calculated as: A(x)=Σ[1+a] (f(a)×a(a))\hat{ }N, within a selective time frame x,

where f(a) represents frequency and a (a) represents accuracy; where N represents the number of organizational layers in the vertical and horizontal structure.

Or in simplified form: A=(f×a)\hat{ }N

### Independent Embodiment 6-9 (Profit Trajectory Uplift—PTU)

### PTU/PVU Embodiment Set

### Embodiment 6 (Profit Trajectory Uplift—Functional Form)

A computer-implemented method for calculating the deltas of different velocity targets

The system of embodiment 6, further comprising: computing a Profit Trajectory Uplift (PTU) index that measures the velocity gain in organizational profitability relative to a baseline;

wherein the PTU index represents the change in speed at which the organization collectively reaches profitability targets through improved alignment, synchronization, and decision-making.

### Embodiment 7 (PTU—Velocity-Based Formulation)

The system of embodiment 6, wherein the PTU index is calculated as a Profit Velocity Uplift (PVU) defined by:

$$\begin{matrix}PVU = Δ Return Velocity / Baseline Velocity , \\ where Return Velocity is defined as Return \% / Payback Days . \\ PTU = ( Payback 1 - Payback 2 ) / Payback 2 ,\end{matrix}$$

where Payback1 is defined as the baseline payback timepoint and Payback2 is defined as the improved payback timepoint, each corresponding to the exact time at which cumulative return equals acquisition cost under a given scenario.

### Embodiment 8 (PTU—Time-Based Formulation)

The system of embodiment 6, wherein the PTU index is alternatively calculated by time reduction, defined as:

$$Payback Gain = ( Payback 1 - Payback 2 ) / Payback 1 ,$$

where Payback1 is defined as the baseline payback timepoint and Payback2 is defined as the improved payback timepoint, each corresponding to the exact time at which cumulative return equals acquisition cost under a given scenario.

### Embodiment 9 (PTU—Alternative Names and Terminologies)

The system of embodiment 6, wherein the PTU index may also be referred to as:
Profit Velocity Uplift (PVU),
Payback Gain, Payback Loss Computation, depending on whether the index is calculated in velocity-based format or time-based format.

### Independent Embodiment 10 (Leadership OS)

### Embodiment 10—a Computational Leadership Operating System

A computer-implemented system for organizational decision support, comprising:
a profitability signal module configured to generate a profitability signal in real time based on velocity comparisons, the comparisons comprising at least one of:
a retention curve and a payback curve;
an inactivity curve and a return curve; or
combinations thereof;
wherein the profitability signal is determined by whether the payback velocity exceeds the inactivity velocity and whether the return curve reaches one before the inactivity curve reaches zero.
an alignment module configured to compute an alignment index as a compounded function of frequency and accuracy across organizational layers, optionally represented as a summation or exponential compound form.
a trajectory module configured to compute a profit trajectory uplift (PTU) index representing changes in profitability velocity relative to a baseline trajectory; and
a unified interface configured to integrate and display outputs of the profitability signal module, the alignment module, and the trajectory module,
   wherein the unified interface provides leadership with a centralized operating system for real-time decision-making, organizational synchronization, and growth management.

### Dependent Embodiments (Extensions)

The system of embodiment 10, wherein the unified interface comprises a centralized unified interface module configured to integrate and display outputs that include visualizations of retention curves, return curves, payback curves, profitability signals, alignment indices, and trajectory outputs.

The system of embodiment 10, wherein the unified interface further comprises predictive models configured to forecast trajectory changes under different strategic scenarios.

The system of embodiment 10, wherein the unified interface is configured to generate real-time alerts or control signals in response to threshold changes in the profitability signal, alignment index, or PTU index.

The system of embodiment 10, wherein the profitability signal module further incorporates machine learning models to forecast when the return curve will reach a predefined threshold based on current retention or inactivity dynamics.

The system of embodiment 10, wherein the alignment module or trajectory module incorporates predictive or machine learning models trained on historical or real-time organizational decision data to generate projected alignment indices, PTU values, or adaptive profitability signals.

The system of embodiment 10, wherein the unified interface exposes an application programming interface (API), or equivalent integration interface (including SDKs, plugins, or data connectors) to external systems, enabling real-time distribution of profitability signals, alignment indices, or trajectory outputs across organizational platforms.

The system of embodiment 10, wherein the Leadership Operating System is deployed as a Software-as-a-Service (SaaS) platform, accessible through cloud environment, and configured to provide multi-tenant access to profitability signals, alignment indices, and trajectory outputs in real time.

The system of embodiment 10, wherein the Leadership Operating System further comprises integration of additional standard business metrics including, but not limited to, Customer Acquisition Cost (CAC), Average Revenue Per User (ARPU), revenue, profit, retention rate, Lifetime Value (LTV), Return on Ad Spend (ROAS), or other financial or operational key performance indicators, presented in actual or forecast form.

### Glossary

### Retention and Retention Curve:

Retention: The percentage of users who continue to engage with your product or service over a given period. It measures user loyalty and the product's ability to keep customers active. The flip side of retention rate is the inactivity rate, which measures the percentage of users lost over the same period.

Retention Curve: A graphical representation showing how retention changes over time. It often starts high and declines, but a “flattening” curve indicates stable, long-term user retention.

### Payback:

The amount of time it takes to recover the cost of acquiring a customer (Customer Acquisition Cost or CAC) through the revenue generated by that customer. The flip side of the payback rate is the return rate (or Return on Investment), which focuses on the total profitability achieved over time rather than the time taken to break even.

$$\begin{matrix}Payback Period ( T ) = CAC / Accumulative Revenue ( T ) \\ Payback = 1 / ROI\end{matrix}$$

### Return on Investment (ROI):

A financial metric that calculates the profitability of an investment relative to its cost. In mobile businesses, it often measures the effectiveness of marketing campaigns or product development investments. ROI=Net Profit/Investment Cost×100

### Dynamic Formula for ROI:

$$ROI ( T ) = Cumulative Revenue at Time T / Cost of Acquisition ( CAC )$$

The flip side of ROI is the payback period, which emphasizes how quickly you recoup the investment rather than how much profit is ultimately made—a time dimension.

### Inactivity:

The percentage of users who stop using your product or service over a specific time period. It's the inverse of retention and a key indicator of customer dissatisfaction or unmet expectations.

The flip side of Inactivity rate is the retention rate, which tracks how many users stay active over the

Customer Acquisition Cost (CAC): The average cost to acquire one customer, calculated as total acquisition spend÷number of new customers acquired.

Average Revenue Per User (ARPU): The average revenue generated per active user over a given time period, calculated as total revenue-active users.

Lifetime Value (LTV): The projected net revenue a customer generates over their entire relationship with the company, often computed as ARPU×average customer lifespan.

Return on Ad Spend (ROAS): A ratio of revenue generated from advertising campaigns relative to advertising spend, calculated as:

$$ROAS = LTV / CAC$$

### RPA Framework Data Glossary

Retention Curve (R(t)):

A function computed by the system representing the fraction of users active over time.

Retention Velocity (R′(t)):

The derivative of the retention curve, representing the rate at which users are retained or continue to remain active over time.

### Inactivity Curve (I(t)):

A time-dependent curve representing the rate at which users reduce or cease activity.

### Defined as I(t)=1−R(t)

Also referred to as a churn curve, disengagement curve, or drop-off curve.

### Return Curve (ROI(t)):

Represents cumulative revenue relative to acquisition cost. Acquisition cost may be defined as customer acquisition cost (CAC), and revenue may be expressed as average revenue per user (ARPU). The return curve may also be referred to as an ROI curve, ROAS curve, recoup curve, or cash flow curve. ROI=ARPU/CAC

### Payback Curve (P(t)):

Defined as the reciprocal or inverse of the return curve.

### Inactivity Velocity (I′(t)):

The derivative of the inactivity curve, representing the rate at which users become inactive. Churn velocity may be considered a specific case of inactivity velocity where inactivity results in permanent user loss.

### Payback Velocity (P′(t)):

The derivative of the payback curve, representing the rate at which financial return is achieved. In the context of the present invention, payback velocity may also be referred to as return velocity, since it represents the rate of change of cumulative return on investment (ROI) over time.

### Alignment Metrics

### Alignment Index (A(x)):

A function representing the alignment of an organizational node (such as a leadership decision node or execution node). Alignment is defined as a function of decision or execution frequency×decision or execution accuracy within a defined timeframe x.

$$Alignment ( x ) = ( f ( a ) \times a ( a ) ) \qquad Formula$$

f(a)=frequency of decision or execution events
a(a)=accuracy of decision or execution events
x=timeframe of evaluation

In extended embodiments, Alignment may be expressed as:

$$Alignment ( x ) = \sum [ 1 + a ] ( F ( a ) \times a ( a ) )$$

over a timeframe x.

### Compound Alignment (A(x)):

Represents the aggregated alignment of an organization across both time and organizational layers.

$$A ( x ) = \sum [ 1 + a ] ( f ( a ) \times a ( a ) ) \hat{} N \qquad Formula$$

f(a)=frequency of decision or execution events
a(a)=accuracy of decision or execution events
x=timeframe of evaluation
N=number of vertical and horizontal organizational layers

### Interpretation:

The exponent N is applied to each decision-node or execution-node term (frequency×accuracy) to reflect compounding across organizational layers before summation across the timeframe x.

$$Simplified : A = ( f \times a ) \hat{} N$$

Compound Alignment thus operationalizes organizational alignment as a quantifiable index, transforming “alignment” from a business concept into a measurable mathematical construct.

### Profit Trajectory Metrics

### Profit Trajectory Uplift (PTU):

A metric representing the improvement in profitability trajectory expressed as time reduction in reaching payback.

$$PTU = ( Payback 1 - Payback 2 ) / Payback 2 \qquad Formula$$

Where Payback1 and Payback2 are time points at which cumulative revenue equals acquisition cost before and after an alignment or optimization intervention.

### Interpretation:

PTU quantifies how much faster the organization reaches profitability relative to its baseline trajectory.

### Profit Velocity Uplift (PVU):

A velocity-based alternative to PTU, defined as the relative improvement in return velocity.

$$PVU = Δ Return Velocity / Baseline Velocity \qquad Formula$$

$$Where : Return Velocity ( v ) = Return \% \div Payback Days$$

### Interpretation:

PVU expresses profitability improvement as a change in velocity rather than absolute time reduction.

### Payback Gain (Δ):

An alternative term for PTU when expressed as a percentage of time saved.

$$Payback Gain = ( Payback 1 - Payback 2 ) / Payback 1 \qquad Formula$$

### Data Pipelines (ETL, Streaming, API-based):

Mechanisms for ingesting and harmonizing data across heterogeneous systems, including but not limited to:
ETL pipelines (Extract-Transform-Load): Standardized processes for collecting data from multiple sources, transforming it into a consistent schema, and loading it into the unified framework.

Streaming pipelines: Real-time ingestion frameworks that continuously process event-level data (e.g., user interactions, transactions) to update profitability signals without batch delays. API-based pipelines: Direct integrations with external systems (e.g., product analytics, CRM, marketing platforms, financial systems) that provide structured data in near real-time. In the present invention, such pipelines may be used interchangeably to ensure consistency, timeliness, and reliability of inputs across marketing, product, finance, and organizational platforms.

1. A computer-implemented method for evaluating profitability across different segments of cohorts and users, comprising:
generating a retention curve representing a fraction of users active over time;
generating an inactivity curve defined as one minus the retention curve;
generating a return (ROI) curve representing cumulative revenue relative to acquisition cost;
defining a payback curve as the reciprocal or inverse function of the return curve;
computing an inactivity velocity from the inactivity curve;
computing a payback velocity from the return (ROI) curve;
comparing the retention curve with the return curve to evaluate the dynamic relationship between user activity and financial recovery; and
comparing the inactivity curve with the return curve to evaluate the dynamic relationship between user activity and financial recovery; and
determining profitability signal based on 1) comparing whether the payback velocity exceeds the inactivity velocity and 2) the return curve reaches one before the inactivity curve reaches zero;
wherein the profitability signal is generated in real time across multiple cohorts and user segments.

2. The method of claim 1, wherein the return curve is expressed as an ROI curve, ROAS curve, recoup curve, or cash flow curve.

3. The method of claim 1, wherein the inactivity curve is alternatively referred to as a churn curve, disengagement curve, or drop-off curve.

4. The method of claim 1, wherein the profitability signal is further visualized as a chart displaying retention, inactivity, ROI, and payback curves with color-coded cohort profitability.

5. The method of claim 1, further comprising transmitting the profitability signal as a machine-readable output to one or more analytic, operational, or decision-making modules.

6. The method of claim 1, wherein the analytic modules include a product module, a marketing module, and a finance module, each configured to consume the profitability signal for decision-making.

7. The method of claim 1, wherein the profitability signal module further incorporates machine learning models configured to forecast when the return curve will reach a predefined threshold based on current retention or inactivity dynamics;
The method of claim 1, wherein predictive or machine learning models are employed to estimate future payback velocity or inactivity velocity from historical or real-time cohort data.

8. The method of claim 1, wherein anomaly detection models are applied to identify when projected inactivity velocity is expected to exceed payback velocity, triggering alerts or control signals.

9. The method of claim 1, wherein the profitability determination incorporates organizational interaction points, including decision frequencies or performance events across functional teams;
The method of claim 1, wherein the profitability determination is further associated with organizational interaction patterns derived from decision-making or performance data of functional teams.

10. The method of claim 1, wherein the profitability determination is output as a binary or continuous signal for real-time operational decision-making.

11. A computer-implemented system for organizational decision support, comprising:
a profitability signal module configured to generate a profitability signal in real time based on velocity comparisons, the comparisons comprising at least one of:
a retention curve and a payback curve;
a retention curve and a return curve;
an inactivity curve and a return curve; or
combinations thereof;
wherein the profitability signal is determined by whether the payback velocity exceeds the inactivity velocity and whether the return curve reaches one before the inactivity curve reaches zero;
a unified interface configured to integrate and display outputs of the profitability signal module together with one or more additional organizational metrics or indices, including at least one of alignment indices, profit trajectory uplift (PTU) values, profitability forecasts, or standard business metrics such as CAC, ARPU, revenue, profit, retention rate, LTV, or ROAS.

12. The system of claim 11, wherein the unified interface comprises a centralized unified interface module configured to integrate and display outputs that include visualizations of retention curves, return curves, payback curves, profitability signals, alignment indices, and trajectory outputs.

13. The system of claim 11, wherein the unified interface further comprises predictive models configured to forecast trajectory changes under different strategic scenarios.

14. The system of claim 11, wherein the unified interface is configured to generate real-time alerts or control signals in response to threshold changes in the profitability signal, alignment index, or PTU index.

15. The system of claim 11, wherein the profitability signal module further incorporates machine learning models to forecast when the return curve will reach a predefined threshold based on current retention or inactivity dynamics.

16. The system of claim 11, wherein the alignment module or trajectory module incorporates predictive or machine learning models trained on historical or real-time organizational decision data to generate projected alignment indices, PTU values, or adaptive profitability signals.

17. The system of claim 11, wherein the unified interface exposes an application programming interface (api), or equivalent integration interface (including sdks, plugins, or data connectors) to external systems, enabling real-time distribution of profitability signals, alignment indices, or trajectory outputs across organizational platforms.

18. The system of claim 11, wherein the leadership operating system is deployed as a software-as-a-service (saas) platform, accessible through cloud environment, and configured to provide multi-tenant access to profitability signals, alignment indices, and trajectory outputs in real time.

19. The system of claim 11, wherein the leadership operating system further comprises integration of additional standard business metrics including, but not limited to, customer acquisition cost (CAC), average revenue per user (ARPU), revenue, profit, retention rate, lifetime value (LTV), return on ad spend (ROAS), or other financial or operational key performance indicators, presented in actual or forecast form.
